(19) United States
(12) Patent Application Publication
(10) Pub. No.: US 2013/0219390 A1
(43) Pub. Date: Aug. 22, 2013

(54) CLOUD SERVER AND METHOD FOR CREATING VIRTUAL MACHINES

(71) Applicant: HON HAI PRECISION INDUSTRY CO., LTD., (US)

(72) Inventors: Chung-I LEE, New Taipei (TW); Chien-Fa YEH, New Taipei (TW); Kuan-Chiao PENG, New Taipei (TW); Yen-Hung LIN, New Taipei (TW)

(73) Assignee: HON HAI PRECISION INDUSTRY CO., LTD., New Taipei (TW)

(21) Appl. No.: 13/720,907

(22) Filed: Dec. 19, 2012

(30) Foreign Application Priority Data
Feb. 21, 2012 (TW) 101105567

(51) Int. Cl. G06F 9/455

(52) U.S. Cl. CPC G06F 9/455
USPC 718/1

(57) ABSTRACT

When receiving a notice that a client has logged off the cloud server, a cloud server checks a resource utilization ratio of the cloud server and a resource utilization ratio of a virtual machine (VM) designated to the client. If the resource utilization ratio of the cloud server is not more than a first preset ratio, the cloud server creates a new VM using idle resources of the cloud server. If the resource utilization ratio of the cloud server is more than first preset ratio and the resource utilization ratio of the VM is less than a second preset ratio, the cloud server releases idle resources of the VM, and creates a new VM using the released resources. When receiving a notice that notifies the client is logging back into the cloud server, the cloud server reallocates the released resources to the VM.

### BACKGROUND

1. Technical Field

Embodiments of the present disclosure relate to virtualization technology, and more particularly to a cloud server and a method for creating virtual machines.

2. Description of related art

Virtual machines (VM) are software implementations that create one or more VMs on an operating system (kernel) layer of a server. A guest operating system (OS) is a virtualized environment, and by installing a guest OS in the VMs, multiple guest OS can co-exist and run independently on the same server, so that resources (e.g., such as CPU resource, hard disk resource) of the server can serve more users. Therefore, methods for more efficiently utilizing the limited resources of the server are always desired.

### BRIEF DESCRIPTION OF THE DRAWINGS

FIG. 1 is a block diagram of one embodiment of a cloud server for creating VMs.

FIG. 2 is a block diagram of one embodiment illustrating a network environment of a method for creating VMs.

FIG. 3 is a flowchart of one embodiment of a method for creating VMs.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one”.

In general, the word “module”, as used herein, refers to logic embodied in hardware or firmware, or to a collection of software instructions, written in a programming language. One or more software instructions in the modules may be embedded in firmware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

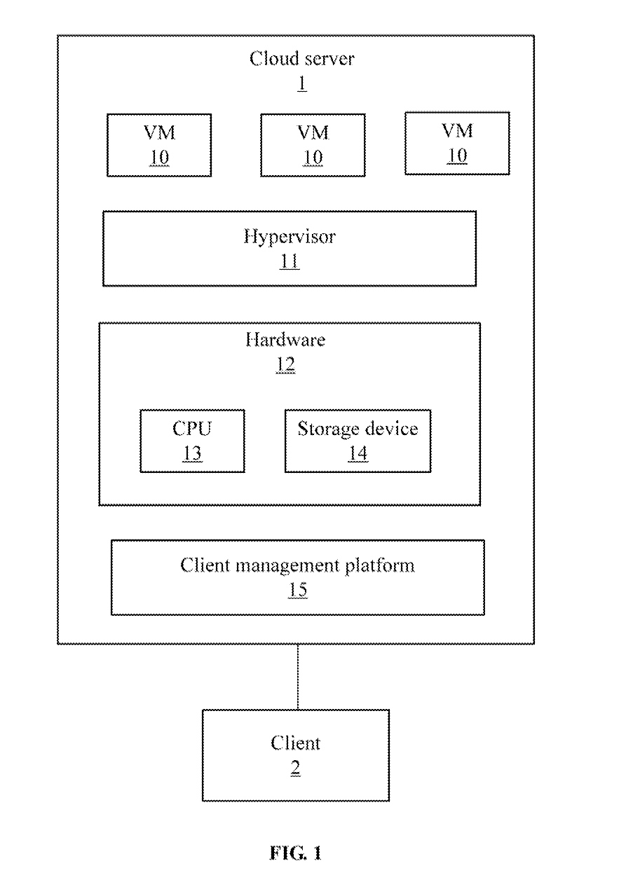

FIG. 1 is a block diagram of one embodiment of a cloud server 1 for creating virtual machines (VMs) 10. The server 1 includes a hypervisor 11, hardware 12, and a client management platform (hereinafter “the platform”) 15. The hardware 12 includes at least one central processing unit (CPU) 13, and at least one storage device 14. The storage device 14 includes hard disks, and solid-state memory, for example. The platform 15 provides an interface for a client 2 to log into or log off the cloud server 1. The client 2 may log into the cloud server 1 to request a designation of a VM 10, and operate the VM 10 designated to the client 2, such as powering on or shutting down the VM 10. The hypervisor 11 receives the request sent from the client 2 via the platform 15, accesses the hardware 12, and allocates resources (such as CPU resource, hard disk resource, memory resource, and network resource) of the cloud server 1 to create the VM 10 by executing instructions stored within the at least one storage device 14.

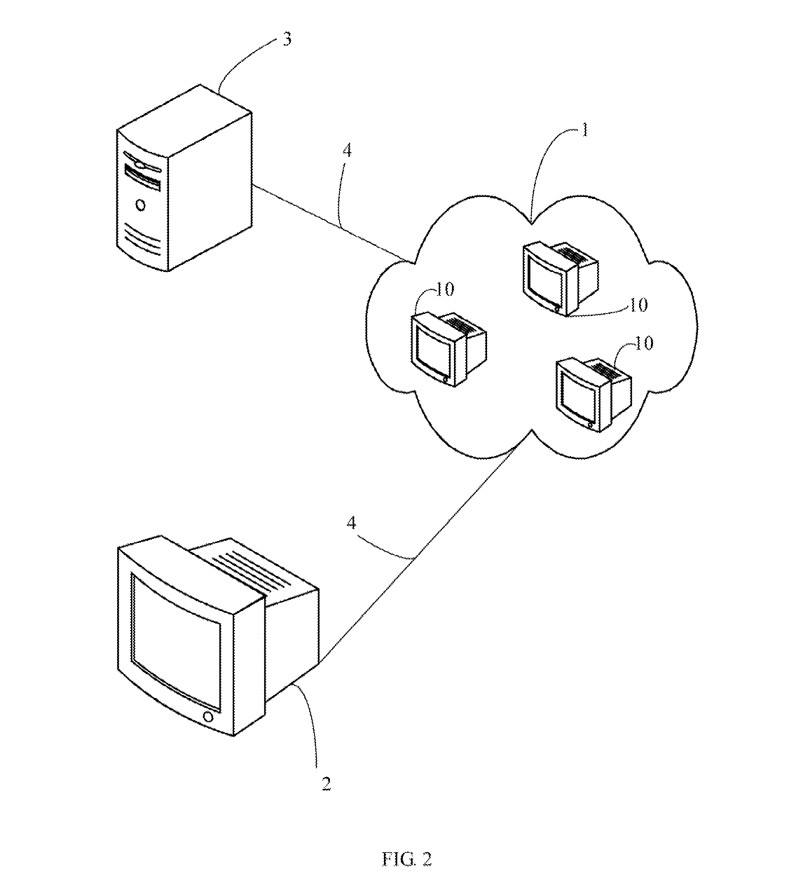

FIG. 2 is a block diagram of one embodiment illustrating a network environment of a method for creating the VMs 10 by the cloud server 1. One or more clients 2 (only one shown in FIG. 2) and a dynamic host configuration protocol (DHCP) server 3 communicates with the cloud server 1 via a network 4. The network 4 may be a wide area network (e.g., the Internet) or a local area network.

The DHCP server 3 is installed with a DHCP service. The DHCP server 3 assigns Internet protocol (IP) addresses to the VMs 10. In one embodiment, the DHCP server 3 uses dynamic allocation to assign the IP addresses to the VMs 10. The hypervisor 11 monitors a resource utilization ratio of each VM 10 and a resource utilization ratio of the cloud server 1, and receives notices that notifies log in/log off information of the clients 2 sent from the platform 15. In one embodiment, the resource utilization ratio of the VM 10 includes a utilization ratio of the CPU resource allocated to the VM 10 (hereinafter “a CPU utilization ratio”), a utilization ratio of hard disk resource allocated to the VM 10 (hereinafter “a hard disk utilization ratio”), a utilization ratio of memory resource allocated to the VM 10(hereinafter “a memory utilization ratio”), and a utilization ratio of network resource allocated to the VM 10 (hereinafter “a network utilization ratio”). For example, the memory utilization ratio of the VM 10 indicates an amount of memory resource that is used by the VM 10 to an amount of memory resource that is allocated to the VM 10 by the cloud server 1. If 50 GB of memory is allocated to the VM 10, and the VM 10 uses 20 GB during a present run, then the memory utilization ratio of the VM 10 is: 20 GB/50 GB=40%.

The resource utilization ratio of the cloud server 1 includes a CPU utilization ratio, a hard disk utilization ratio, a memory utilization ratio, and a network utilization ratio of the cloud server 1. For example, the memory utilization ratio of the cloud server 1 indicates an amount of memory resource that has been allocated to create the VMs 10 to a total amount of the memory resource. If the total amount of the memory resource is 500 GB, where 300 GB have been allocated to create the VMs 10, then the memory utilization ratio of the cloud server 1 is: 300 GB /500 GB =60%.

In one embodiment, when receiving a notice that notifies a client 2 has logged off the cloud server 1 from the platform 15, if the hypervisor 11 determines the resource utilization ratio of the cloud server is more than a first preset ratio (such as 80%), and determines the resource utilization ratio of the VM 10 designated to the client 2 is less than a second preset ratio (such as 50%), the hypervisor 11 release resources of the VM 10 designated to the client 2, and creates one or more new VMs 10 using the release resources. In one embodiment, if the resource utilization ratio of the cloud server is more than the first preset ratio, it indicates that idle resources of the cloud server 1 is insufficient to create more VMs 10. If the resource utilization ratio of the VM 10 is less than the second preset ratio, it indicates that the VM 10 has much idle resources.

The idle resources of the cloud server 1 may be determined as insufficient on condition that any one of the CPU utilization ratio, the hard disk utilization ratio, the memory utilization ratio, and the network utilization ratio of the cloud server is more than the first preset value, or may be determined as insufficient on condition that each of the CPU utilization ratio, the hard disk utilization ratio, the memory utilization ratio, and the network utilization ratio of the cloud server 1 is more than the first preset value. It is noted that, the CPU utilization ratio, the hard disk utilization ratio, the memory utilization ratio, and the network utilization ratio of the cloud server 1 may correspond to the same first preset ratio (such as 80%), or respectively correspond to a corresponding first preset ratio (such as 85%, 78%, 83%, 86%).

Accordingly, the VM 10 may be determined has much idle resources on condition that any one of the CPU utilization ratio, the hard disk utilization ratio, the memory utilization ratio, and the network utilization ratio of the VM 10 is less than the second preset ratio, or on condition that each of the CPU utilization ratio, the hard disk utilization ratio, the memory utilization ratio, and the network utilization ratio of the VM 10 is less than the second preset ratio. Furthermore, the CPU utilization ratio, the hard disk utilization ratio, the memory utilization ratio, and the network utilization ratio of the VM 10 may correspond to the same second preset value (such as 50%), or respectively correspond to a corresponding second preset value (such as 55%, 54%, 40%, 30%).

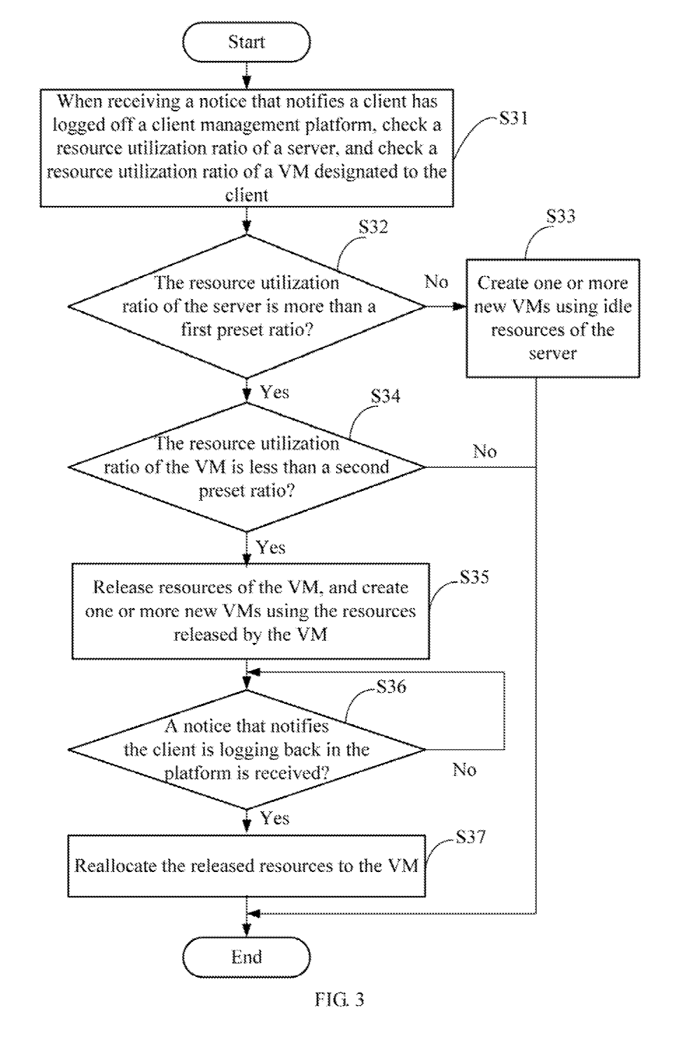

FIG. 3 is a flowchart of one embodiment of a method for creating VMs 10 with the cloud server 1. Depending on the embodiment, additional steps may be added, others removed, and the ordering of the steps may be changed.

In step S31, when the hypervisor 11 of the server 100 receives a notice that notifies a client 2 has logged off the cloud server 1 from the platform 15, the hypervisor 11 checks a resource utilization ratio of the cloud server 1, and checks a resource utilization ratio of a VM 10 designated to the client 2. As mentioned above, the resource utilization ratio of the cloud server 1 includes a CPU utilization ratio, a hard disk utilization ratio, a memory utilization ratio, and a network utilization ratio of the cloud server 1. The resource utilization ratio of the VM 10 includes a CPU utilization ratio, a hard disk utilization ratio, a memory utilization ratio, and a network utilization ratio of the VM 10.

In step S32, the hypervisor 11 determines if idle resources of the cloud server 1 is sufficient for creating one or more new VMs 10 by determining if the resource utilization ratio of the cloud server 1 is more than a first preset ratio. As mentioned above, if the resource utilization ratio of the cloud server 1 is more than the first preset ratio, the idle resources of the cloud server 1 is determined as insufficient. In this embodiment, the CPU utilization ratio, the hard disk utilization ratio, the memory utilization ratio, and the network utilization ratio of the cloud server 1 corresponds to the same first preset value (such as 80%). If any one of the CPU utilization ratio, the hard disk utilization ratio, the memory utilization ratio, and the network utilization ratio of the cloud server 1 is more than the first preset ratio (such as 80%), the idle resources of the cloud server 1 is determined as insufficient, and step S34 is implemented. If the resource utilization ratio of the cloud server 1 is equal to or less than the first preset ratio, the idle resources of the cloud server 1 is determined as sufficient. For example, if each of the CPU utilization ratio, the hard disk utilization ratio, the memory utilization ratio, and the network utilization ratio of the cloud server 1 is equal to or less than the first preset ratio (such as 80%), step S33 is implemented.

In step S33, the hypervisor 11 creates one or more new VMs 10 using the idle resources of the cloud server 1. For example, the hypervisor 11 may create a new VM 10 with a first type by allocating one CPU kernel, 2G memory, and 100G hard disk from the idle resources, and create a VM 10 with a second type by allocating two CPU kernel, 4G memory, and 150G hard disk from the idle resources. Then, the procedure ends.

In step S34, the hypervisor 11 determines if the resource utilization ratio of the VM 10 allocated to the client 2 is less than a second preset ratio. In this embodiment, the CPU utilization ratio, the hard disk utilization ratio, the memory utilization ratio, and the network utilization ratio of the VM 10 correspond to the same second preset value (such as 50%). If any one of the CPU utilization ratio, the hard disk utilization ratio, the memory utilization ratio, and the network utilization ratio of the VM 10 allocated to the client 2 is less than the second preset ratio (such as 50%), the VM 10 is determined as having much idle resources, and step S35 is implemented. For example, the VM 10 may be shut down or switched into a sleep status by the client 2 before the client 2 logging off the cloud server 1, thus the resources allocated to the VM 10 may be less utilized. If each of the CPU utilization ratio, the hard disk utilization ratio, the memory utilization ratio, and the network utilization ratio of the VM 10 is equal to or more than the second preset ratio, the hypervisor 11 determines that the VM 10 has less idle resources, and the procedure ends.

In step S35, the hypervisor 11 releases the idle resources of the VM 10 designated to the client 2 that has logged off the cloud server 1, and creates one or more new VMs 10 using the released resources. For example, if the VM 10 designated to the client 2 that has logged off the cloud server 1 is shut down, the whole resources of the VM 10 may be released. For another example, the hypervisor 11 may only release a part of the idle resources of the VM 10, depending on preset rules for releasing the idle resources.

In step S36, the hypervisor 11 monitors for a notice that notifies the client 2 is logging back into the platform 15. If the notice is received that the client 2 is logging back into the platform 15, step S37 is implemented, the hypervisor 11 reallocated the released resources to the VM 10 that is designated to the client 2.

The above embodiments releases idle resources of created VMs 10 to create new VMs 10, and returns the released resources to corresponding VMs 10 when clients of the VMs 10 logs back into the cloud server. Thus, resources of the cloud server can be efficiently used and would not influence running of the created VMs 10.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A method being executed by a processor of a cloud server for creating virtual machines (VMs), the method comprising:
checking a resource utilization ratio of the cloud server and a resource utilization ratio of a VM designated to a client electronically connected to the cloud server, when receiving a notice that notifies the client has logged off the cloud server;
creating one or more new VMs using idle resources of the cloud server on condition that the resource utilization ratio of the cloud server is equal to or less than a first preset ratio, or releasing idle resources of the VM designated to the client, and creating one or more new VMs using the released resources, on condition that the resource utilization ratio of the cloud server is more than first preset ratio and the resource utilization ratio of the VM designated to the client is less than a second preset ratio; and
reallocating the released resources to the VM designated to the client when receiving a notice that notifies the client is logging back into the cloud server.

2. The method of claim 1, wherein the notices are received via a client management platform, which provides an interface for the client to log into or log off the cloud server, and allows the client to perform operations to the VM designated to the client.

3. The method of claim 1, wherein the resource utilization ratio of the cloud server comprises a CPU utilization ratio, a hard disk utilization ratio, a memory utilization ratio, and a network utilization ratio of the cloud server.

4. The method of claim 3, the idle resources of the cloud server are determined as being insufficient on condition that any one of the CPU utilization ratio, the hard disk utilization ratio, the memory utilization ratio, and the network utilization ratio of the cloud server is more than the first preset value, or on condition that each of the CPU utilization ratio, the hard disk utilization ratio, the memory utilization ratio, and the network utilization ratio of the cloud server is more than the first preset value.

5. The method of claim 1, wherein the resource utilization ratio of the VM comprises a CPU utilization ratio, a hard disk utilization ratio, a memory utilization ratio, and a network utilization ratio of the VM.

6. The method of claim 5, wherein the VM is determined as having too much idle resources on condition that any one of the CPU utilization ratio, the hard disk utilization ratio, the memory utilization ratio, and the network utilization ratio of the VM is less than the second preset ratio, or on condition that each of the CPU utilization ratio, the hard disk utilization ratio, the memory utilization ratio, and the network utilization ratio of the of the VM is less than the second preset ratio.

7. A cloud server, comprising:
at least one central processing unit (CPU);
at least one storage device comprising memory and one or more hard disks;
a hypervisor that executes instructions stored within the at least one storage device to:
check a resource utilization ratio of the cloud server and a resource utilization ratio of a virtual machine (VM) designated to a client electronically connected to the cloud server when receiving a notice that notifies the client has logged off the cloud server;
create one or more new VMs using idle resources of the cloud server on condition that the resource utilization ratio of the cloud server is equal to or less than a first preset ratio, or release idle resources of the VM designated to the client, and create one or more new VMs using the released resources, on condition that the resource utilization ratio of the cloud server is more than first preset ratio and the resource utilization ratio of the VM designated to the client is less than a second preset ratio; and
reallocate the released resources to the VM designated to the client when receiving a notice that notifies the client is logging back into the cloud server.

8. The cloud server of claim 7, wherein the notices are received via a client management platform, which provides an interface for the client to log into or log off the cloud server, and allows the client to perform operations to the VM designated to the client.

9. The cloud server of claim 7, wherein the resource utilization ratio of the cloud server comprises a CPU utilization ratio, a hard disk utilization ratio, a memory utilization ratio, and a network utilization ratio of the cloud server.

10. The cloud server of claim 9, the idle resources of the cloud server are determined as being insufficient on condition that any one of the CPU utilization ratio, the hard disk utilization ratio, the memory utilization ratio, and the network utilization ratio of the cloud server is more than the first preset value, or on condition that each of the CPU utilization ratio, the hard disk utilization ratio, the memory utilization ratio, and the network utilization ratio of the cloud server is more than the first preset value.

11. The cloud server of claim 7, wherein the resource utilization ratio of the VM comprises a CPU utilization ratio, a hard disk utilization ratio, a memory utilization ratio, and a network utilization ratio of the VM.

12. The cloud server of claim 11, wherein the VM is determined as having too much idle resources on condition that any one of the CPU utilization ratio, the hard disk utilization ratio, the memory utilization ratio, and the network utilization ratio of the VM is less than the second preset ratio, or on condition that each of the CPU utilization ratio, the hard disk utilization ratio, the memory utilization ratio, and the network utilization ratio of the of the VM is less than the second preset ratio.

13. A non-transitory computer-readable medium having stored thereon instructions that, when executed by a processor of a cloud server, causing the cloud server to perform a method for creating virtual machines (VMs), the method comprising:
checking a resource utilization ratio of the cloud server and a resource utilization ratio of a VM designated to a client electronically connected to the cloud server when receiving a notice that notifies the client has logged off the cloud server;
creating one or more new VMs using idle resources of the cloud server on condition that the resource utilization ratio of the cloud server is equal to or less than a first preset ratio, or releasing idle resources of the VM designated to the client, and creating one or more new VMs using the released resources, on condition that the resource utilization ratio of the cloud server is more than first preset ratio and the resource utilization ratio of the VM designated to the client is less than a second preset ratio; and
reallocating the released resources to the VM designated to the client when receiving a notice that notifies the client is logging back into the cloud server.

14. The medium of claim 13, wherein the notices are received via a client management platform, which provides an interface for the client to log into or log off the cloud server, and allows the client to perform operations to the VM designated to the client.

15. The medium of claim 13, wherein the resource utilization ratio of the cloud server comprises a CPU utilization ratio, a hard disk utilization ratio, a memory utilization ratio, and a network utilization ratio of the cloud server.

16. The medium of claim 15, wherein the idle resources of the cloud server are determined as being insufficient on condition that any one of the CPU utilization ratio, the hard disk utilization ratio, the memory utilization ratio, and the network utilization ratio of the cloud server is more than the first preset value, or on condition that each of the CPU utilization ratio, the hard disk utilization ratio, the memory utilization ratio, and the network utilization ratio of the cloud server is more than the first preset value.

17. The medium of claim 13, wherein the resource utilization ratio of the VM comprises a CPU utilization ratio, a hard disk utilization ratio, a memory utilization ratio, and a network utilization ratio of the VM.

18. The medium of claim 16, wherein the VM is determined as having much idle resources on condition that any one of the CPU utilization ratio, the hard disk utilization ratio, the memory utilization ratio, and the network utilization ratio of the VM is less than the second preset ratio, or on condition that each of the CPU utilization ratio, the hard disk utilization ratio, the memory utilization ratio, and the network utilization ratio of the of the VM is less than the second preset ratio.
